(19) United States
(12) Patent Application Publication
(10) Pub. No.: US 2016/0133940 A1
(43) Pub. Date: May 12, 2016

(54) ELECTRODE FOR SECONDARY BATTERY AND LITHIUM SECONDARY BATTERY INCLUDING THE SAME

(71) Applicant: LG Chem, Ltd., Seoul (KR)

(72) Inventors: Kyoung Ho Kim, Daejeon (KR); Je Young Kim, Daejeon (KR); Ji Yoon Kwon, Daejeon (KR); Hoe Jin Hah, Daejeon (KR); Il Hong Kim, Daejeon (KR); In Sung Uhm, Daejeon (KR)

(73) Assignee: LG Chem, Ltd., Seoul (KR)

(21) Appl. No.: 14/888,626

(22) PCT Filed: Jul. 25, 2014
(86) PCT No.: PCT/KR2014/006816

§ 371 Date: Nov. 2, 2015

(30) Foreign Application Priority Data
Jul. 29, 2013 (KR) 10-2013-0089285

(51) Int. Cl. H01M 4/66; H01M 10/0525; H01M 4/62

(52) U.S. Cl. CPC H01M 4/66; H01M 4/661; H01M 4/622; H01M 4/623; H01M 10/0525; H01M 2220/30

(57) ABSTRACT

Disclosed is an electrode including a current collector having a functional group or a radical binding with an electrode material on a surface thereof, and an electrode mixture layer formed on the current collector.

### TECHNICAL FIELD

The present invention relates to an electrode for a secondary battery and a lithium secondary battery including the same.

### BACKGROUND ART

As mobile device technology continues to develop and demand therefor continues to increase, demand for secondary batteries as energy sources is rapidly increasing. Among these secondary batteries, lithium secondary batteries which have high energy density and voltage and exhibit long lifespan and low self-discharge rate are commercially available and widely used.

Such secondary batteries use graphite as a negative electrode active material and charge and discharge thereof are performed by repeating a process wherein lithium ions of a positive electrode are intercalated into and deintercalated from a negative electrode. Even though there is a difference in the theoretical capacity of the battery depending upon kinds of electrode active materials, the charge/discharge capacity of the battery generally decreases as the number of charge/discharge cycles increases.

The primary cause of such a phenomenon is a failure to sufficiently fulfill functions of the electrode active material due to separation between the electrode active materials and/or between the electrode active material and current collector, resulting from volume changes of electrodes occurring during repeated charge/discharge cycles of the battery. Further, since the lithium ions inserted into the negative electrode are not normally released from the negative electrode during the intercalation and deintercalation process, the active points of the negative electrode are decreased. Consequently, further increase in the number of charge/discharge cycles also leads to decrease of the charge/discharge capacity and deterioration of lifespan characteristics of the battery.

In particular, when natural graphite having a theoretical discharge capacity of 372 mAh/g is used with a material having a large discharge capacity such as silicon, tin, silicon-tin alloy or the like in order to increase discharge capacity, volume expansion of a material dramatically increases as charge and discharge proceed, and thus, a negative electrode material is released from an electrode material. As a result, the capacity of a battery is rapidly decreased as repetitive cycling proceeds.

Conventionally, in order to prevent separation between electrode active materials, or between an electrode active material and a current collector, technology of adding a material such as polyvinylidene fluoride (PVdF) or the like having strong adhesive strength as a solvent based binder has been suggested. However, fundamental problems such as increase of battery internal resistance depending upon the amount of a binder used and decreased output cannot be resolved.

Therefore, there is an urgent need for technology to resolve such problems.

### DISCLOSURE

### Technical Problem

Therefore, the present invention has been made to solve the above and other technical problems that have yet to be resolved.

The present invention aims to provide an electrode for secondary batteries having superior adhesion and bearing capacity with respect to an electrode current collector and an electrode active material, and a lithium secondary battery including the same.

### Technical Solution

Therefore, in a non-limiting embodiment of the present invention, provided is an electrode including a current collector having a functional group or a radical binding with an electrode material on a surface thereof, and an electrode mixture layer formed on the current collector.

The functional group may be a polar group.

The functional group may be at least one selected from the group consisting of a hydroxyl group, a carboxylic group, a carbonyl group, an aldehyde group, an amine group and a fluorine group.

The functional group may chemically bind with an electrode material.

The functional group may hydrogen-bind with an electrode material.

A water contact angle of the current collector layer may be 5 degrees to 30 degrees.

The functional group or the radical may be introduced using at least one method selected from the group consisting of a corona surface modification method, a plasma surface modification method, an ultraviolet surface modification method and an electron ray surface modification method.

The current collector may be composed of a metal material.

In addition, a metal oxide having a functional group may be present on a surface of the metal current collector.

The current collector may be an aluminum current collector or a copper current collector.

The electrode material may be at least one binding polymer selected from the group consisting of a fluororesin based binding polymer including polyvinylidene fluoride (PVdF) or polytetrafluoroethylene (PTFE), a rubber based binding polymer including styrene-butadiene rubber, acrylonitrile-butadiene rubber or styrene-isoprene rubber, a cellulose based binding polymer including carboxymethyl cellulose (CMC), starch, hydroxypropylcellulose or regenerated cellulose, a polyalcohol based binding polymer, a polyolefin based binding polymer including polyethylene or polypropylene, a polyimide based binding polymer and a polyester based binding polymer.

In addition, the present invention may provide a battery including the electrode.

The battery may be one selected from the group consisting of lithium ion batteries, lithium ion polymer batteries and lithium polymer batteries.

In general, the battery is composed of a positive electrode, a negative electrode, a separator disposed between the positive electrode and the negative electrode, and a lithium salt-containing non-aqueous electrolyte, and other components of the battery are described below.

In general, the positive electrode is prepared by drying after coating a mixture of a positive electrode active material, a conductive material and a binder, as an electrode mixture, on a positive electrode current collector. In this case, as desired, the mixture may further include a filler.

Examples of the positive electrode active material may include layered compounds such as lithium cobalt oxide (LiCoO₂) and lithium nickel oxide (LiNiO₂) or compounds substituted with one or more transition metals; lithium manganese oxides represented by Li₁₊ₓMn₂₋ₓO₄ where 0≦x≦0.33, such as LiMnO₃, LiMn₂O₃, and LiMnO₂; lithium copper oxide (Li_{2 C}uO₂); vanadium oxides such as LiV₃O₈, LiV₃O₄, V₂O₅, and Cu₂V₂O₇; Ni-site type lithium nickel oxides having the formula LiNi₁₋ₓMₓO₂ where M=Co, Mn, Al, Cu, Fe, Mg, B, or Ga, and 0.01≦x≦0.3; lithium manganese composite oxides having the formula LiMn₂₋ₓMₓO₂ where M=Co, Ni, Fe, Cr, Zn, or Ta, and 0.01≦x≦0.1 or the formula Li₂Mn₃MO₈ where M=Fe, Co, Ni, Cu, or Zn; spinel-structure lithium manganese composite oxides represented by LiNiₓMn₂₋ₓO₄; LiMn₂O₄ where some of the Li atoms are substituted with alkaline earth metal ions; disulfide compounds; Fe₂(MoO₄)₃; and the like, but embodiments of the present invention are not limited thereto.

The positive electrode current collector is generally fabricated to a thickness of 3 to 500 μm. The positive electrode current collector is not particularly limited so long as it does not cause chemical changes in the fabricated lithium secondary battery and has high conductivity. For example, the positive electrode current collector may be made of stainless steel, aluminum, nickel, titanium, sintered carbon, aluminum or stainless steel surface-treated with carbon, nickel, titanium, or silver, or the like. The positive electrode current collector may have fine irregularities at a surface thereof to increase adhesion between the positive electrode active material and the positive electrode current collector. In addition, the positive electrode current collector may be used in any of various forms including films, sheets, foils, nets, porous structures, foams, and non-woven fabrics.

The conductive material is generally added in an amount of 1 to 50 wt % based on the total weight of a mixture including a positive electrode active material. There is no particular limit as to the conductive material, so long as it does not cause chemical changes in the fabricated battery and has conductivity. For example, graphite such as natural or artificial graphite; carbon black such as carbon black, acetylene black, Ketjen black, channel black, furnace black, lamp black, and thermal black; conductive fibers such as carbon fibers and metallic fibers; metallic powders such as carbon fluoride powder, aluminum powder, and nickel powder; conductive whiskers such as zinc oxide whiskers and potassium titanate whiskers; conductive metal oxides such as titanium oxide; conductive materials such as polyphenylene derivatives; and the like may be used.

Meanwhile, the graphite based material having elasticity may be used as the conductive material and may be used with the other materials.

The binder is a component assisting in binding between an active material and the conductive material and in binding of the active material to a current collector. The binder is typically added in an amount of 1 to 50 wt % based on the total weight of the mixture including the positive electrode active material. Examples of the binder include, but are not limited to, polyvinylidene fluoride, polyvinyl alcohols, carboxymethylcellulose (CMC), starch, hydroxypropylcellulose, regenerated cellulose, polyvinyl pyrrolidone, tetrafluoroethylene, polyethylene, polypropylene, ethylene-propylene-diene terpolymer (EPDM), sulfonated EPDM, styrene butadiene rubber, fluorine rubber, and various copolymers.

The filler is optionally used as a component to inhibit positive electrode expansion. The filler is not particularly limited so long as it is a fibrous material that does not cause chemical changes in the fabricated battery. Examples of the filler include olefin-based polymers such as polyethylene and polypropylene; and fibrous materials such as glass fiber and carbon fiber.

The present invention also provides a secondary battery including the electrode, and the secondary battery may be a lithium ion battery, a lithium ion polymer battery, or a lithium polymer battery.

The negative electrode may be prepared by coating, drying and pressing a negative electrode active material on a negative electrode current collector. As desired, the conductive material, the binder, the filler and the like described above may be selectively further included.

Examples of the negative electrode active material include carbon such as hard carbon and graphite-based carbon; metal composite oxides such as LiₓFe₂O₃ where 0≦x≦1, LiₓWO₂ where 0≦x≦1, SnₓMe₁₋ₓMe′_{y}O_{z} where Me: Mn, Fe, Pb, or Ge; Me′: Al, B, P, Si, Group I, II and III elements, or halogens; 0<x≦1; 1≦y≦3; and 1≦z≦8; lithium metals; lithium alloys; silicon-based alloys; tin-based alloys; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; conductive polymers such as polyacetylene; and Li-Co-Ni-based materials.; titanium oxides; lithium titanium oxides; and the like, particularly carbon based materials and/or Si.

The negative electrode current collector is typically fabricated to a thickness of 3 to 500 μm. The negative electrode current collector is not particularly limited so long as it does not cause chemical changes in the fabricated battery and has conductivity. For example, the negative electrode current collector may be made of copper, stainless steel, aluminum, nickel, titanium, sintered carbon, copper or stainless steel surface-treated with carbon, nickel, titanium, or silver, and aluminum-cadmium alloys. Similar to the positive electrode current collector, the negative electrode current collector may also have fine irregularities at a surface thereof to enhance adhesion between the negative electrode current collector and the negative electrode active material and may be used in various forms including films, sheets, foils, nets, porous structures, foams, and non-woven fabrics.

The separator is disposed between the positive electrode and the negative electrode and, as the separator, a thin insulating film with high ion permeability and high mechanical strength is used. The separator generally has a pore diameter of 0.01 to 10 μm and a thickness of 5 to 300 μm. As the separator, for example, sheets or non-woven fabrics, made of an olefin-based polymer such as polypropylene; or glass fibers or polyethylene, which have chemical resistance and hydrophobicity, are used. When a solid electrolyte such as a polymer or the like is used as an electrolyte, the solid electrolyte may also serve as a separator.

The lithium salt-containing non-aqueous electrolyte consists of a non-aqueous electrolyte and lithium. As the non-aqueous electrolyte, a non-aqueous organic solvent, an organic solid electrolyte, an inorganic solid electrolyte or the like may be used, but the present invention is not limited thereto.

Examples of the non-aqueous organic solvent include non-aprotic organic solvents such as N-methyl-2-pyrrolidinone, propylene carbonate, ethylene carbonate, butylene carbonate, dimethyl carbonate, diethyl carbonate, gamma-butyrolactone, 1,2-dimethoxy ethane, tetrahydrofuran, 2-methyl tetrahydrofuran, dimethylsulfoxide, 1,3-dioxolane, formamide, dimethylformamide, dioxolane, acetonitrile, nitromethane, methyl formate, methyl acetate, phosphoric acid triester, trimethoxy methane, dioxolane derivatives, sulfolane, methyl sulfolane, 1,3-dimethyl-2-imidazolidinone, propylene carbonate derivatives, tetrahydrofuran derivatives, ether, methyl propionate, and ethyl propionate.

Examples of the organic solid electrolyte include polyethylene derivatives, polyethylene oxide derivatives, polypropylene oxide derivatives, phosphoric acid ester polymers, polyagitation lysine, polyester sulfide, polyvinyl alcohols, polyvinylidene fluoride, and polymers containing ionic dissociation groups.

Examples of the inorganic solid electrolyte include, but are not limited to, nitrides, halides and sulfates of lithium (Li) such as Li₃N, LiI, Li₅NI₂, Li₃N-LiI-LiOH, LiSiO₄, LiSiO₄-LiI-LiOH, Li₂SiS₃, Li₄SiO₄, Li₄SiO₄-LiI-LiOH, and Li₃PO₄-Li₂S-SiS₂

The lithium salt is a material that is readily soluble in the non-aqueous electrolyte and examples thereof include, but are not limited to, LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, (CF₃SO₂)₂NLi, chloroborane lithium, lower aliphatic carboxylic acid lithium, lithium tetraphenyl borate, and imides.

In addition, in order to improve charge/discharge characteristics and flame retardancy, for example, pyridine, triethylphosphite, triethanolamine, cyclic ether, ethylenediamine, n-glyme, hexaphosphoric triamide, nitrobenzene derivatives, sulfur, quinone imine dyes, N-substituted oxazolidinone, N,N-substituted imidazolidine, ethylene glycol dialkyl ether, ammonium salts, pyrrole, 2-methoxy ethanol, aluminum trichloride or the like may be added to the lithium salt-containing non-aqueous electrolyte. If necessary, in order to impart incombustibility, the electrolyte may further include halogen-containing solvents such as carbon tetrachloride and ethylene trifluoride. Further, in order to improve high-temperature storage characteristics, the non-aqueous electrolyte may further include carbon dioxide gas, and fluoro-ethylene carbonate (FEC), propene sultone (PRS) and the like may be further included.

In one specific embodiment, a lithium salt-containing non-aqueous electrolyte may be prepared by adding a lithium salt such as LiPF₆, LiClO₄, LiBF₄, LiN(SO_{2 C}F₃)₂, or the like to a mixed solvent including EC or PC, which is a high dielectric solvent and a cyclic carbonate, and DEC, DMC, or EMC, which is a low viscosity solvent and a linear carbonate.

The present invention provides a battery pack including the battery and a device including the battery pack as a power source.

In this regard, particular examples of the device include, but are not limited to, electric motor-driven power tools; electric vehicles (EVs), hybrid electric vehicles (HEVs), and plug-in hybrid electric vehicles (PHEVs); electric two-wheeled vehicles such as e-bikes and e-scooters; electric golf carts; and systems for storing power.

### BRIEF DESCRIPTION OF THE DRAWINGS

The above and other objects, features and other advantages of the present invention will be more clearly understood from the following detailed description taken in conjunction with the accompanying drawings, in which:

FIGS. 1 and 2 illustrate graphs representing lifespan characteristics according to Experimental Example 3.

### MODE FOR INVENTION

Now, the present invention will be described in more detail with reference to the accompanying drawings. These examples are provided for illustrative purposes only and should not be construed as limiting the scope and spirit of the present invention.

### Example 1

Manufacture of positive electrode

Li(L_{i1.2}Co_{0.1}Ni_{0.1}Mn_{0.6})O₂ as a positive electrode active material, carbon black as a conductive material and PVdF as a binder were added to n-methyl-2-pyrrolidone (NMP) in a weight ratio of 95:2:3 and mixed, thereby preparing a positive electrode mixture.

Using aluminum foil having a thickness of 20 μm and a plasma surface modification method, a positive electrode current collector having a metal oxide that had a hydrophilic functional group on a surface of the aluminum foil was manufactured.

The prepared positive electrode mixture was coated on the positive electrode current collector to a thickness of 80 μm, and then rolling and drying were performed, thereby manufacturing a positive electrode.

Manufacture of negative electrode

A natural graphite/Si based active material as a negative electrode, carbon black as a conductive material, SBR as a binder and CMC as a thickener were added to H₂O in a weight ratio of 94:2:3:1 and mixed, thereby preparing a negative electrode mixture.

Using copper foil having a thickness of 20 μm and a plasma surface modification method, a negative electrode current collector having metal oxide that had a hydrophilic functional group existed on a surface of copper foil was manufactured.

The prepared negative electrode mixture was coated on the negative electrode current collector to a thickness of 80 μm, and then rolling and drying were performed, thereby manufacturing a positive electrode.

Surface treatment of current collector

In a manufacturing process of the current collector, the current collector was surface-treated through a plasma treatment method. According to the plasma treatment, electrons were accelerated due to an electric field when MF of 12 kW was added, and thus, active species generated through ionization of GN2 (N₂) gas and CDA (clean dry air) gas struck aluminum foil or copper foil having a size of 250 mm*250 mm, thereby treating a surface of the current collector.

Manufacture of secondary battery

A separator (Celgard™, thickness: 20 μm) was disposed between the negative electrode and the positive electrode, thereby manufacturing an electrode assembly. Subsequently, the electrode assembly was accommodated in a pouch type battery case, and a non-aqueous lithium electrolyte solution, in which ethyl carbonate, dimethyl carbonate and ethylmethyl carbonate were mixed in a volumetric ratio of 1:1:1 and which included 1 M LiPF₆ as a lithium salt, was added, thereby manufacturing a lithium secondary battery.

### Comparative Example 1

A lithium secondary battery was manufactured in the same manner as in Example 1, except that aluminum foil, which was not separately surface-treated, as a positive electrode current collector and copper foil, which was not separately surface-treated, as a negative electrode current collector were used.

### Experimental Example 1

In order to confirm that surfaces of the Al foil current collector and Cu foil current collector according to Example 1 became hydrophilic through the plasma surface treatment, contact angles were measured. The positive electrode current collector and the negative electrode current collector according to Example 1 were cut and fixed to slide glasses. Subsequently, a 3 uL droplet of H₂O was placed thereon to measure a contact angle. Results are summarized in Table 1 below.

### Experimental Example 2

Adhesive strength experiments were carried out using the electrodes according to Example 1 and Comparative Example 1. The electrode according to each of Example 1 and Comparative Example 1 was cut and fixed to a slide glass. Subsequently, 180-degree peel strength thereof was measured while peeling off the electrode current collector. For evaluation, five or more peel strengths were measured and an average value thereof was calculated. Results are summarized in Table 2 below.

TABLE 2

| | Adhesive strength of | Adhesive strength of |
|---|---|---|
| | positive electrode | negative electrode |
| Example 1 | 24 gf/cm | 14 gf/cm |
| Comparative Example 1 | 11 gf/cm | 8 gf/cm |

### Experimental Example 3

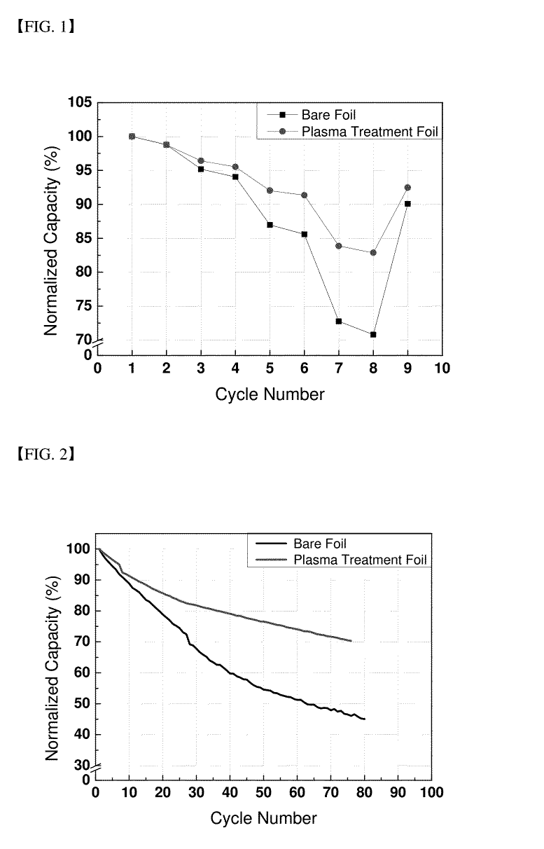

Charge/discharge tests for the batteries according to Example 1 and Comparative Example 1 were carried out by charging up to a final charge voltage of 4.25 V at a charge current of 0.1 C at 25° C., and then, while changing a discharge rate into 0.1 C, 0.2 C, 0.5 C, 1 C and 0.1 C, 2 cycle-discharging at each rate (1 cycle only at 0.1 C) up to a final discharge voltage of 2.5 V. FIG. 1 and Table 3 below show discharge capacities of 0.2 C, 0.5 C and 1 C with respect to a discharge capacity of 0.1 C. FIG. 2 below illustrates results of charge/discharge cycle tests for the batteries according to Example 1 and Comparative Example 1, which were discharged up to a final discharge voltage of 2.5 V at a discharge current of 0.5 C after charging up to a final charge voltage of 4.25 V at a charge current of 0.2 C at 45° C.

TABLE 3

| | 0.2 C discharge | 0.5 C discharge | 1 C discharge |
|---|---|---|---|
| | capacity | capacity | capacity |
| | (2nd cycle)/ | (2nd cycle)/ | (2nd Cycle)/ |
| | 0.1 C discharge | 0.1 C discharge | 0.1 C discharge |
| | capacity (%) | capacity (%) | capacity (%) |
| Example 1 | 95.5% | 91.3% | 82.9% |
| Comparative | 94.8% | 88.1% | 75.9% |
| Example 1 | | | |

According to Experimental Examples 2 and 3, it can be confirmed that the battery according to Example 1 exhibits superior adhesive strength, and improved rate and cycle characteristics, when compared with the battery according to Comparative Example 1.

This is since, by applying the current collector including the metal oxide, to which a hydrophilic functional group was introduced, to surfaces of the aluminum foil and the copper foil constituting the positive electrode current collector and the negative electrode current collector using the plasma surface modification method in the manufacturing process of the battery, adhesive strength between the electrode current collector and the electrode mixture is improved, and thus, decrease in electrical conductivity and capacity may be prevented. Therefore, when the manufacturing method according to the present invention is applied to both the positive electrode and the negative electrode, rate and cycle characteristics may be further improved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

As described above, by using an electrode according to the present invention, an electrode for secondary batteries having superior adhesion and bearing capacity with respect to an electrode current collector and an electrode active material, and a lithium secondary battery including the same may be provided.

1. An electrode comprising:
a current collector having a functional group or a radical binding with an electrode material on a surface thereof; and
an electrode mixture layer formed on the current collector.

2. The electrode according to claim 1, wherein the functional group is a polar group.

3. The electrode according to claim 1, wherein the functional group is at least one selected from the group consisting of a hydroxyl group, a carboxylic group, a carbonyl group, an aldehyde group, an amine group and a fluorine group.

4. The electrode according to claim 1, wherein the functional group chemically binds with an electrode material.

5. The electrode according to claim 4, wherein the functional group hydrogen-binds with an electrode material.

6. The electrode according to claim 1, wherein a water contact angle of the current collector layer is 5 degrees to 30 degrees.

7. The electrode according to claim 1, wherein the functional group or the radical is introduced using at least one method selected from the group consisting of a corona surface modification method, a plasma surface modification method, an ultraviolet surface modification method and an electron ray surface modification method.

8. The electrode according to claim 1, wherein the current collector is composed of a metal material.

9. The electrode according to claim 8, wherein a metal oxide having a functional group is present on a surface of the metal current collector.

10. The electrode according to claim 1, wherein the current collector is an aluminum current collector or a copper current collector.

11. The electrode according to claim 1, wherein the electrode material is at least one binding polymer selected from the group consisting of a fluororesin based binding polymer comprising polyvinylidene fluoride (PVdF) or polytetrafluoroethylene (PTFE), a rubber based binding polymer comprising styrene-butadiene rubber, acrylonitrile-butadiene rubber or styrene-isoprene rubber, a cellulose based binding polymer comprising carboxymethyl cellulose (CMC), starch, hydroxypropylcellulose or regenerated cellulose, a polyalcohol based binding polymer, a polyolefin based binding polymer comprising polyethylene or polypropylene, a polyimide based binding polymer and a polyester based binding polymer.

12. A battery comprising the electrode according to claim 1.

13. The battery according to claim 12, wherein the battery is selected from a lithium ion battery, a lithium polymer battery and a lithium ion polymer battery.

14. A battery pack comprising the battery according to claim 12.

15. A device comprising the battery pack according to claim 14.
